(19) United States
(12) Patent Application Publication
(10) Pub. No.: US 2016/0090208 A1
(43) Pub. Date: Mar. 31, 2016

(54) Shipping Container and Forkstrap Connector Therefor

(71) Applicant: MACRO PLASTICS, INC., Fairfield, CA (US)

(72) Inventor: Todd T. Turner, Corydon, IN (US)

(21) Appl. No.: 14/785,770

(22) PCT Filed: May 12, 2014
(86) PCT No.: PCT/US14/37668

§ 371 Date: Oct. 20, 2015

Related U.S. Application Data
(60) Provisional application No. 61/822,543, filed on May 13, 2013.

(51) Int. Cl. B65D 19/06; F16B 2/20

(52) U.S. Cl. CPC B65D 19/06; F16B 2/20; B65D 2519/00273; B65D 2519/00572

(57) ABSTRACT

A forkstrap connector for removably connecting individual forkstraps or a forkstrap unit to a shipping container, said forkstrap connector including plurality of barbs for engaging the forkstraps of forkstrap unit and a shipping container utilizing at least one forkstrap connector.

### CROSS-REFERENCE TO RELATED APPLICATIONS

This application claims priority to U.S. Provisional Patent Application No. 61/822,543 filed on 13 May 2013, which is hereby incorporated by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention generally relates to returnable shipping containers, and more specifically to shipping containers having replaceable forkstraps or a replaceable forkstrap unit.

2. General Background of the Invention

For many years, industries dealing in bulk goods have utilized returnable containers. A common problem is that containers have to be scrapped at great cost due to damage to the forkstraps many other containers must be scrapped because all or a portion of the connector used to join the forkstraps to the base is formed integrally with the base, rendering the base unusable if even a single connector is damaged.

Additional issues arise due to the fact that known integral connectors rely on interlocking connections that, as a practical matter, make them extremely difficult to remove. The reason for this is that a forkstrap must be retained with sufficient force that it will not inadvertently disconnect under normal use conditions. Thus, the forkstrap must be able to resist a separating force applied to even if more than one loaded container being carried on tips to one side, and such containers often carry 2000 pounds in bulk goods in addition to the weight of the container. Accordingly, as a practical matter, many users will scrap a container with a damaged forkstrap, even if the forkstrap is theoretically replaceable, because the force required to remove the forkstrap often damages the base or the integral connectors or both (or at least renders the integral connectors unreliable).

What is needed then is a reusable bulk container with removable forkstraps, wherein the connectors affixing the forkstrap to the base are not integral to the base or the forkstrap and wherein the forkstrap can be separated from the base without using undo force while the connector, while in use, will provide sufficient retention force to prevent inadvertent separating during use.

### SUMMARY OF THE INVENTION

The present invention relates to a reusable shipping container having a forkstrap unit (or separate forkstraps) that is removably connected to the base of the container, and more particularly to such a container that uses a connector to connect the forkstrap unit to the base that is not integral to the forkstrap unit or the base.

### BRIEF DESCRIPTION OF THE DRAWINGS

For a further understanding of the nature, objects, and advantages of the present invention, reference should. be had to the following detailed description, read in conjunction with the attached figures, wherein like reference numerals denote like elements.

FIG. 1 is perspective of the base of a container showing a forkstrap unit affixed to the base using an embodiment of the forkstrap connector.

FIG. 2 is a perspective view of Detail A with an embodiment of the forkstrap connector installed.

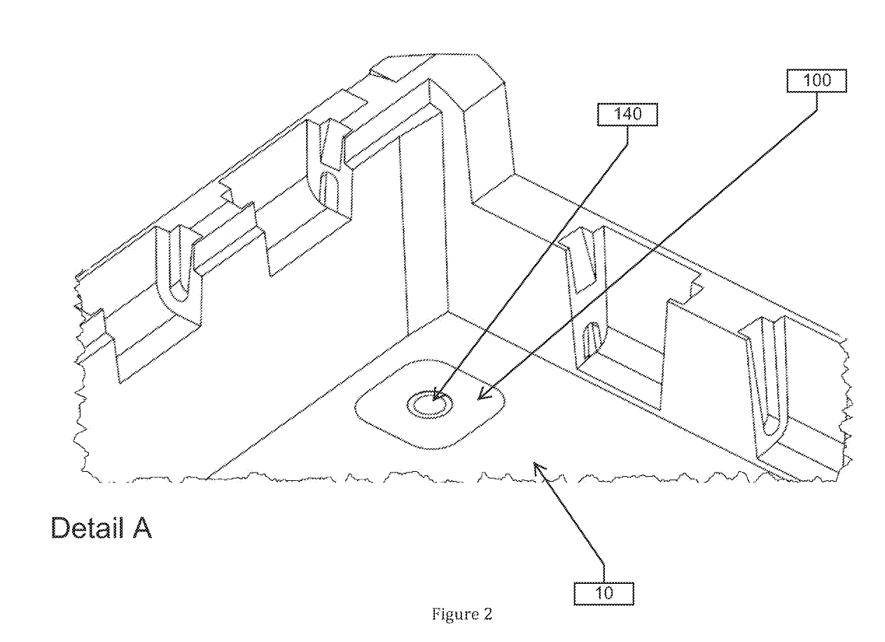

FIG. 3 is an exploded perspective view of Detail A.

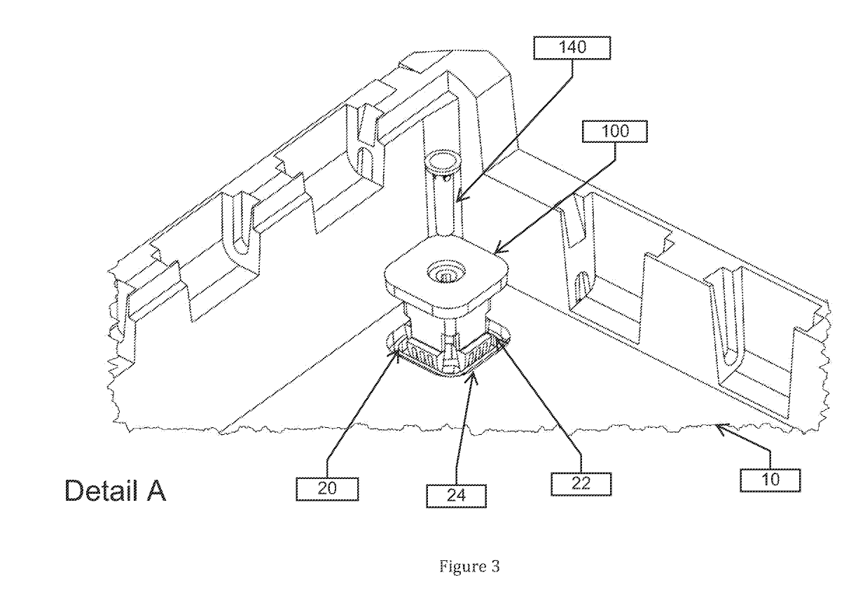

FIG. 4 is bottom perspective view showing the embodiment of the forkstrap unit from FIG. 1 installed on the embodiment of the base from FIG. 1.

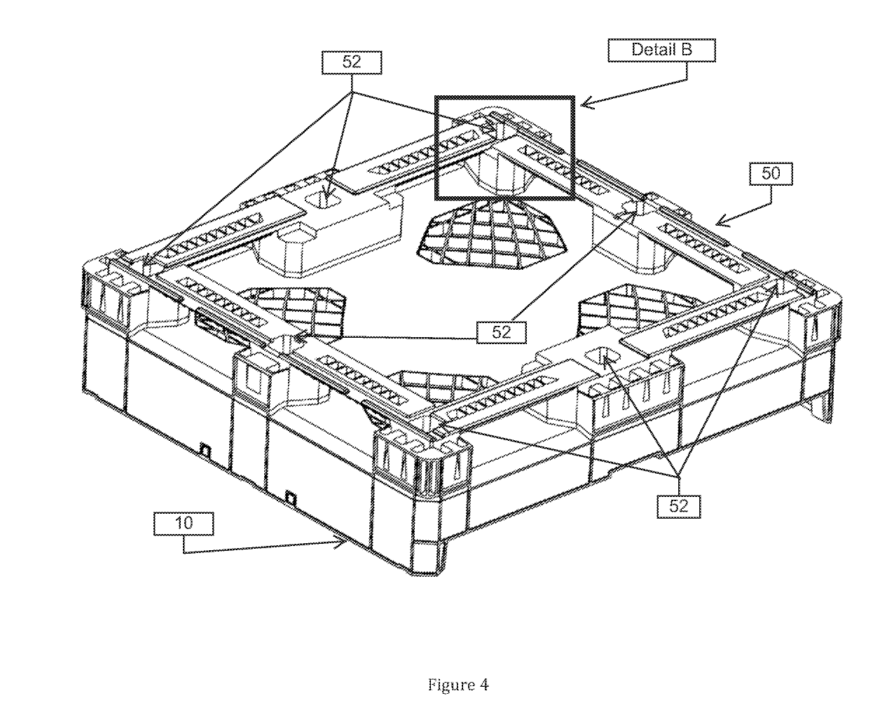

FIG. 5 is a perspective view of Detail B showing the embodiment of the forkstrap connector from FIG. 3 fully installed.

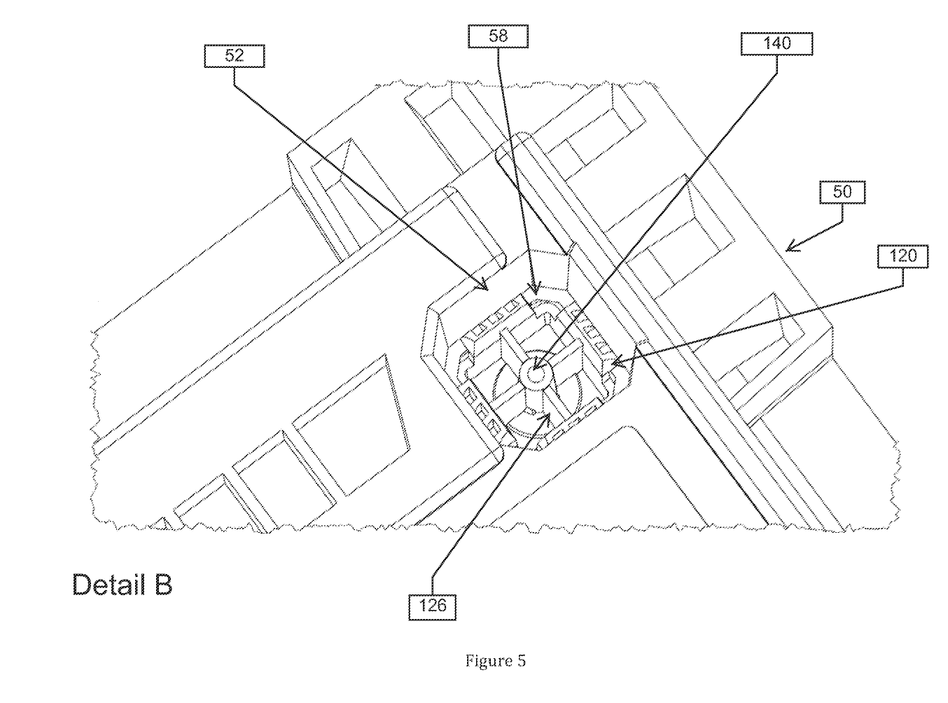

FIG. 6 is a perspective view of Detail B showing the embodiment of the forkstrap connector from FIG. 3 with the locking pin removed.

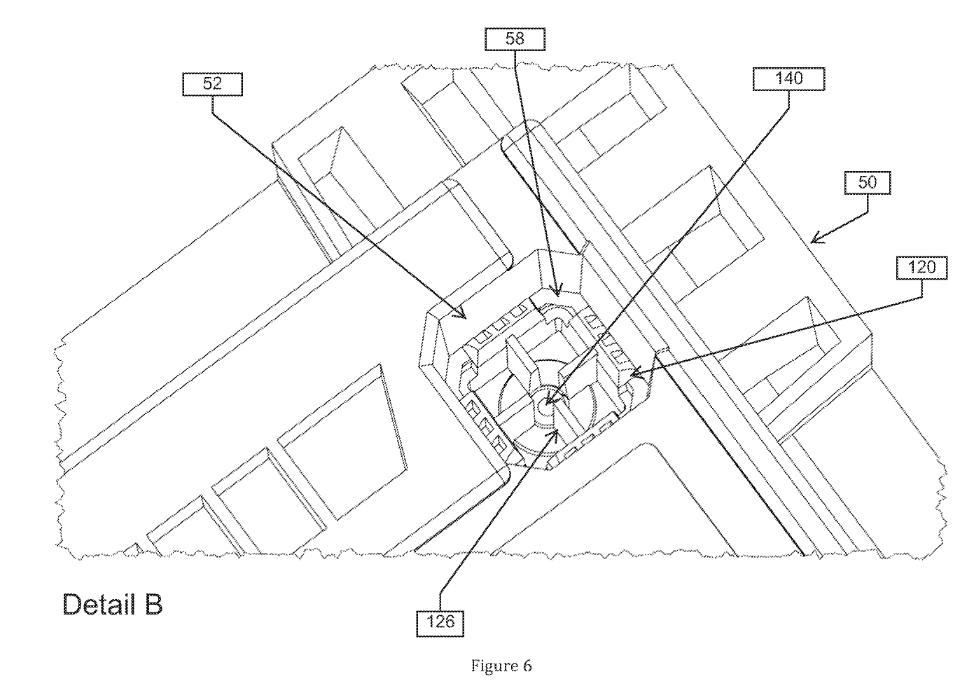

FIG. 7 is a perspective view of Detail B showing the embodiment of the forkstrap connector from FIG. 3 disengaged.

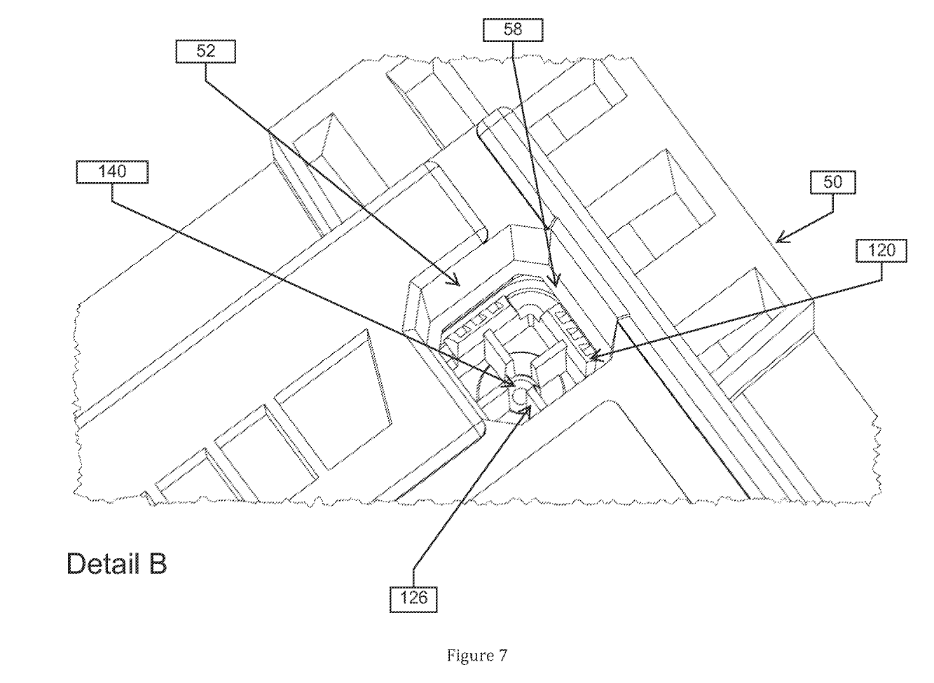

FIG. 8 is an explode perspective view of the embodiment from FIG. 1.

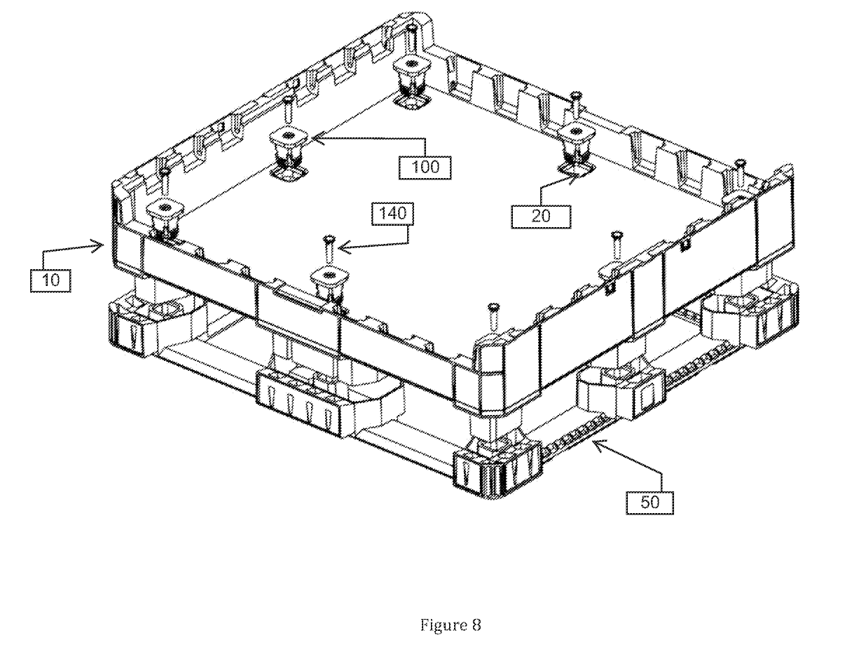

FIG. 9 is an exploded perspective view of an embodiment of the forkstrap connector and locking pin.

FIG. 10 is a partially exploded perspective view of an embodiment of the forkstrap connector and locking pin.

### DETAILED DESCRIPTION OF THE INVENTION

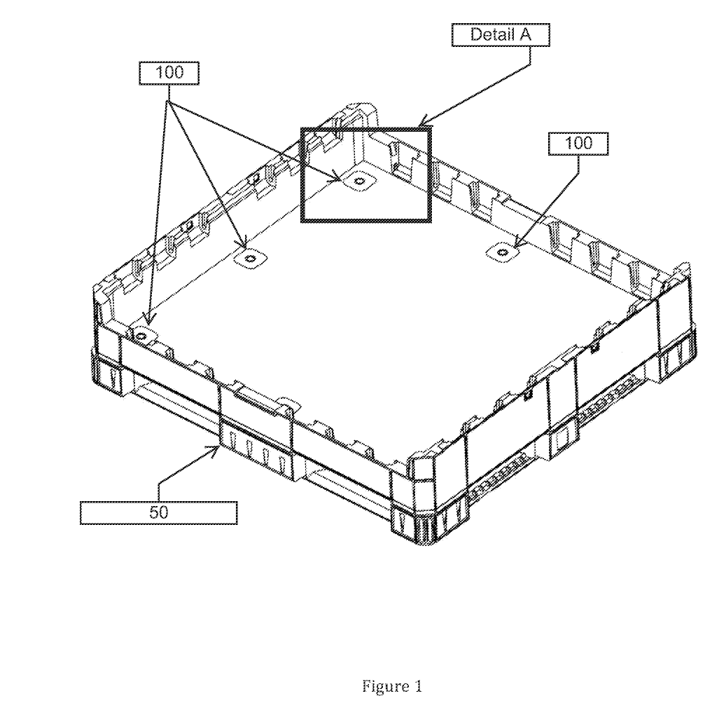

The present invention is a shipping container for bulk goods. Referring to FIG. 1, container 1 comprises rectangular base 10, forkstrap unit 50, and connectors 100. It should be noted that for many applications container I would include a plurality of sidewalls. These sidewalls could take on a multitude of configurations ranging from sidewalls that can be folded for shipment or rigid sidewalls. The particular configurations of walls is, however, not relevant to the present invention that relates to how the forkstraps are interconnected to the base.

Base 10 further comprises a plurality of apertures 20. In the illustrated embodiment, each aperture 20 is defined by a vertical surface that terminates in rim 22; the upper surface of rim 22 being below upper surface 12 of base 10 by a distance equal to the thickness of plate 110 of connector 100. Rim 22 is surrounded by channel 24 for receiving skirt 112 of connector 100.

Connector 100 comprises plate 110. Defined in the center of connector 100 is aperture 102 for receiving locking pin 140. Plate 110 may be recessed as shown around aperture 102 in the illustration to allow head portion 142 of locking pin 140 to be flush with upper surface 12 of base 10 when locking pin 140 is fully inserted. Skirt 112 extends downward from the perimeter portion of plate 110.

Spaced apart from and inward of skirt 112, barbs 120 extend downward from the lower surface of plate 110. Each barb 120 terminates in outward-facing wedge-shaped portion 122. The upper portion of wedge-shaped portion 122 forms ledge 124. Each barb 120 may be joined to adjacent barbs 120 from the lower surface of plate 110 to an intermediate point to add rigidity as required for the particular application. Each barb 120 is additionally adapted to receive outward pressure from locking pin 140. In the illustrated embodiment, this adaptation comprises rib 126 that extends inward from barb 120.

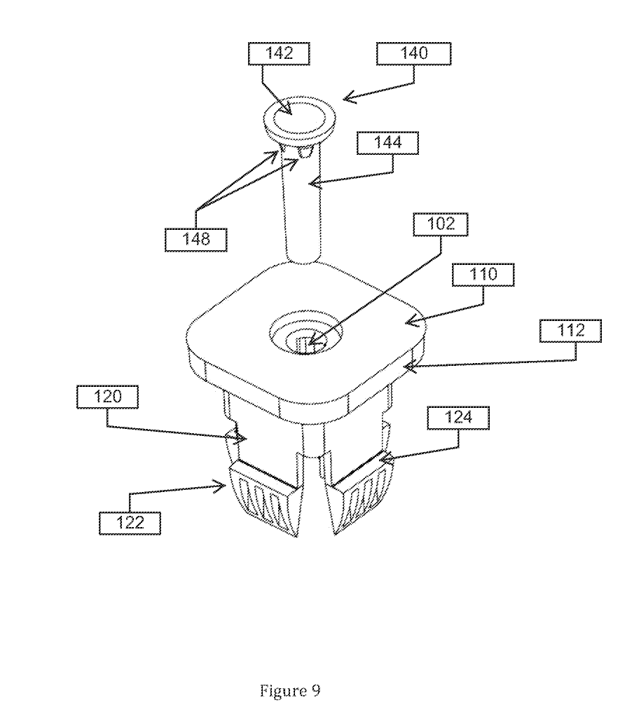

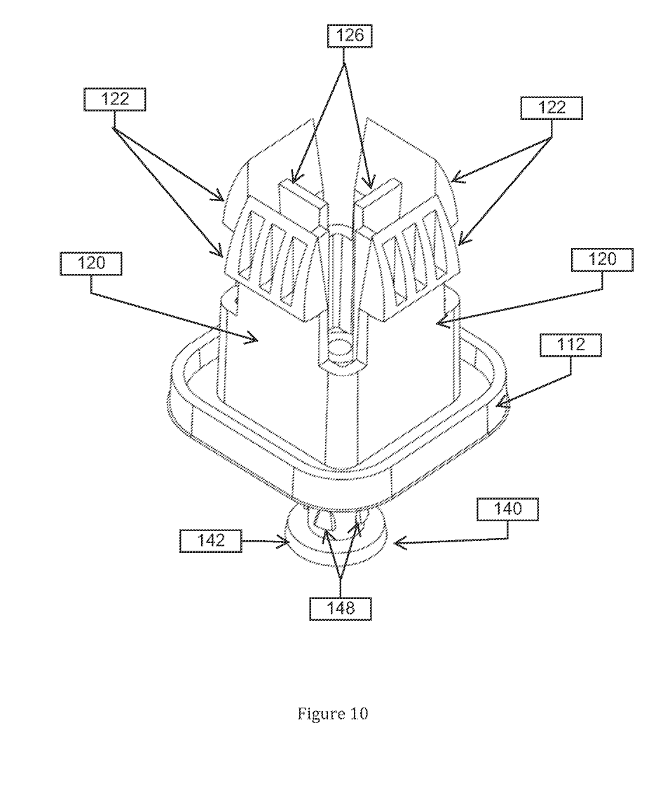

Locking pin 140 comprises head portion 142. Extending downward from head portion 142 is shaft 144; shaft 144 having a diameter sufficient to apply an outward pressure on ribs 126. Locking pin 140 further includes a retention mechanism to ensure that locking pin 140 remains in place once it is fully inserted. In the illustrated embodiment, this retention mechanism comprises a plurality of ramp-shaped retention protrusions 148 (best seen in FIGS. 9 and 10) extending outward from shaft 144. The upper surface of retention protrusions 148 are located such that when locking pin 140 is fully-inserted into forkstrap connector 100, the upper surface of retention protrusions 148 impinge On the lower surface of plate 110, preventing locking pin 140 from inadvertently being removed from forkstrap connector 100. In an alternate embodiment, locking pin 140 can terminate in an annular ring (not shown), the annular ring having a diameter slightly greater than shaft 144. Shaft 144 has a length sufficient to permit the upper surface of the annular to engage the lower surface of ribs 126 when locking pin 140 is fully inserted such that lower surface of head portion 142 is engaged with the upper surface of plate 110 (or the upper surface of the recessed area defined around aperture 102).

Forkstrap unit 50 includes receptacles 52 arising from the upper surface of the forkstrap unit, with receptacles 52 being located to align with latching apertures 20 defined in base 10. The upper portion of each receptacle 52 defines aperture 56. The inner surface of receptacle 52 surrounding aperture 56 forms latching surface 58. While the illustrated embodiment is drawn to an integrated forkstrap unit, the invention is equally applicable to containers using individual forkstraps. In such an application, each forkstrap would include a plurality of receptacles to align with a subset of apertures 20 in base unit 10.

When a connector 100 is inserted into an aperture 20 in base unit 10, barbs 120 extend through aperture 56 in receptacle 52 with the wedge-shaped portions 122 of barbs 120 facilitating installation (at the upper end portion of wedge-shaped, portion 122 where the wedge is the widest, the barbs collectively are slightly further apart than the size of aperture 56 causing barbs 120 to be bent toward the center of aperture 56 as connector 100 is inserted). Once wedge-shaped portion 122 clears aperture 56 in receptacle 50, barbs 120 spring back, causing ledge 124 to impinge on latching surface, thereby joining forkstrap unit 50 to base 10. While the illustrated embodiment is drawn toward a configuration of four barbs, more or less barbs could be utilized (for example two opposing barbs) and the arrangement could be in a different pattern such as circular or triangular or some other shape (the shape of the apertures in the base and forkstrap unit would also be circular or triangular or other shape as the case may be).

To augment the strength of the connection and to preclude forkstrap unit 50 from becoming inadvertently disconnected from base unit 10, locking pin 140 is then inserted through aperture 106 in connector 100. Once full inserted, connector 100 is fixed in place with retention protrusions 148 impinging against the lower surface of plate 110 and the lower surface of head portion 142 impinging against the upper surface of plate 110 (or the upper surface of the recessed area defined around aperture 102). Locking pin 140 thereby precludes barbs 120 from being bent inward and allowing forkstrap unit 50 to disconnect from base 10 inadvertently.

If forkstrap unit 50 or connector 100 or both become damaged, replacement is facilitated by first removing locking pin 140. Forkstrap unit 50 can then be separated from base 10 without the use of undue force. Thus, the central, and most costly, portion of container 1, base 10 (and the sides), do not become scrap solely because forkstrap unit 50 or connector 100 is damaged. This is critical because forkstraps and connectors are the most commonly damaged portions of reusable shipping containers and the most common reason such containers have to be scrapped.

The foregoing described embodiments are exemplary in nature and are not intended to limit the scope of the invention.

1. A shipping container comprising:
a base, said base defining a plurality of apertures;
a forkstrap unit comprising a plurality of receptacles, said receptacles being arranged such that each of said plurality of receptacles aligns with one of the plurality of apertures defined by the base;
a plurality of forkstrap connectors, each forkstrap connector further comprising a plate, a locking aperture defined in said plate, and a plurality of barbs extending downward through said plate;
and a plurality of locking pins,
said forkstrap unit being connected to said base by inserting one of said plurality of forkstrap connectors through each aperture of said plurality of apertures defined in said base such that the plurality of barbs associated with the forkstrap connector extend into the corresponding receptacle of said plurality of receptacles in said forkstrap unit and then inserting one of said plurality of locking pins through the locking aperture in the plate of the forkstrap connector such that the locking pin abuts and applies outward pressure on each barb.

2. The shipping container of claim 1 wherein each aperture of said plurality of apertures defined by said base is surrounded by a rim and the rim is surrounded by a channel and wherein the plate of each of said plurality of forkstrap connectors includes a skirt extending downward from a perimeter portion of the plate, said skirt being received by said channel when the forkstrap connector is inserted into said aperture.

3. The shipping container of claim 2 wherein an upper surface of the rim surrounding each aperture of said plurality of apertures defined by the base unit is offset below the height of an upper surface of the base unit such that when one of the plurality of forkstrap connectors is inserted into one of said plurality of apertures defined by the base an upper surface of the plate of the forkstrap connector aligns with the upper surface of the base unit.

4. The shipping container of claim 3 wherein the each of the plurality of forkstrap connectors further comprises a recessed area defined around the locking aperture in the plate of the forkstrap connector, said recessed area being configured to receive a head portion of one of the plurality of locking pins such that an upper surface of the head portion of the locking pin aligns with the upper surface of the plate of the forkstrap connector.

5. The shipping container of claim 1 wherein each of the plurality of receptacles in said forkstrap unit further comprise a latching surface, said latching surface being adjacent to the base unit when the forkstrap unit is connected to the base unit and said latching surface being located such that when the forkstrap unit is connected to the base unit the plurality of barbs associated with each of the plurality of forkstrap connectors impinge a bottom side of the latching surface.

6. A forkstrap connector apparatus for a shipping container comprising
a forkstrap connector; said forkstrap connector further comprising
a plate,
a locking aperture defined in said plate, said locking aperture being located in a center portion of the plate and being surrounded by a recess in an upper surface of the plate, and
a plurality of barbs extending downward from said plate; and
a locking pin, said locking pin being sized to be received by the locking aperture in the plate of the forkstrap connector unit and said locking pin having a head portion, said head portion being sized to be received by said recess surrounding the locking aperture, a shaft portion, and at least one retention protrusion extending outward from said shaft portion; such that when the locking pin is fully inserted an upper surface of the head portion is flush with an upper surface of the plate of the forkstrap connector into the locking aperture and said at least one retention protrusion impinges against a lower surface of said plate;
wherein said plurality of barbs are configured to engage with an outer surface of the shaft portion of the locking pin when the locking pin is fully inserted into the locking aperture.

7. A shipping container comprising:
a forkstrap unit, said forkstrap unit having a plurality of receptacles extending upward from the forkstrap unit and each of said plurality of receptacles defining a aperture in its upper surface;
a rectangular base unit, said rectangular base unit defining a plurality of apertures, said apertures being arranged such that each of said plurality of apertures defined by the base units with one of the apertures defined by each of the plurality of receptacles;
a plurality of forkstrap connectors connecting the forkstrap unit to the base unit, each of said plurality of forkstrap connectors extending through said aligned apertures, each of said plurality of forkstrap connectors comprising
a plate,
a locking aperture defined in said plate, and
a plurality of barbs extending downward from said plate and arranged to engage one of said plurality of receptacles; and
a plurality of locking pins, each locking pin of said plurality of locking pins extending downward through the locking aperture in the plate of one of said plurality of forkstrap connectors and each locking pin of said plurality of locking pins abutting each barb of said plurality of barbs of the forkstrap connector; each locking pin further comprising a plurality of retention protrusions extending outward from a shaft portion of said locking pin.

8. (canceled)

9. (canceled)
